(19) United States
(12) Patent Application Publication
(10) Pub. No.: US 2026/0205491 A1
(43) Pub. Date: Jul. 16, 2026

(54) DATA SECURITY IN CONTAINERIZED DISTRIBUTED COMPUTING ENVIRONMENTS

(71) Applicant: INTERNATIONAL BUSINESS MACHINES CORPORATION, Armonk, NY (US)

(72) Inventors: Shrutika NIPANE, Kalyan East (IN); Saurabh Sunil WANI, Pune (IN); Abhishek JAIN, Baraut (IN); Deepak R. GHUGE, Ahmednagar (IN)

(21) Appl. No.: 19/024,463

(22) Filed: Jan. 16, 2025

(51) Int. Cl. H04L 9/40

(52) U.S. Cl. CPC H04L 63/1441

(57) ABSTRACT

A method, system, and computer program product configured to perform operations including: identifying a storage subsystem that is associated with a cyber threat, wherein the storage subsystem is in a cluster in a distributed computing system; instructing a container storage interface in the cluster to clear a queue of pending operations associated with the storage subsystem; determining a priority operation associated with the storage subsystem for mitigating the cyber threat; and sending the priority operation to the container storage interface for processing.

### BACKGROUND

Aspects of the present invention relate generally to distributed computing systems and, more particularly, to data security in containerized distributed computing environments.

Malware refers to malicious software or code designed to cause damage to data and system components in a computer system and/or network. Malware poses a major threat in cyber security. Ransomware is a kind of malware that can prevent users from accessing their computing device resources and/or data using various methods.

### SUMMARY

In a first aspect of the invention, there is a method including: identifying a storage subsystem that is associated with a cyber threat, wherein the storage subsystem is in a cluster in a distributed computing system; instructing a container storage interface in the cluster to clear a queue of pending operations associated with the storage subsystem; determining a priority operation associated with the storage subsystem for mitigating the cyber threat; and sending the priority operation to the container storage interface for processing.

In another aspect of the invention, there is a computer program product comprising one or more computer-readable storage media and program instructions stored on the one or more computer-readable storage media to perform operations comprising: identifying a storage subsystem that is associated with a cyber threat, wherein the storage subsystem is in a cluster in a distributed computing system; instructing a container storage interface in the cluster to clear a queue of pending operations associated with the storage subsystem; determining a priority operation associated with the storage subsystem for mitigating the cyber threat; and sending the priority operation to the container storage interface for processing.

In another aspect of the invention, there is a computer system comprising a processor set, one or more computer-readable storage media, and program instructions stored on the one or more computer-readable storage media to cause the processor set to perform operations comprising: identifying a storage subsystem that is associated with a cyber threat, wherein the storage subsystem is in a cluster in a distributed computing system; instructing a container storage interface in the cluster to clear a queue of pending operations associated with the storage subsystem; determining a priority operation associated with the storage subsystem for mitigating the cyber threat; and sending the priority operation to the container storage interface for processing.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows an exemplary use case that illustrates aspects of the invention.

FIG. 4 shows an exemplary use case that illustrates aspects of the invention.

FIG. 5 shows a flowchart of an exemplary method in accordance with aspects of the present invention.

FIG. 6 shows a flowchart of an exemplary method in accordance with aspects of the present invention.

### DETAILED DESCRIPTION

Aspects of the present invention relate generally to distributed computing systems and, more particularly, to data security in containerized distributed computing environments. In accordance with aspects of the invention, a system, method, and computer program product are configured to prioritize container storge interface operations in a distributed computing system in response to a cyber threat such as a ransomware attack directed toward a storage subsystem in the distributed computing system. Implementations provide a watcher service proxy that is configured to provide instructions to the container storge interface to discard queued operations associated with the affected storage subsystem and to perform priority operations associated with mitigating the threat. In embodiments, the watcher service proxy is further configured to dynamically provision a validating webhook that intercepts and blocks external requests for storage volume operations associated with the affected storage subsystem, while permitting the processing of internal requests. In embodiments, the webhook may be configured to block external requests associated with some particular storage volumes in the affected storage subsystem while permitting the processing of external requests associated with other storage volumes in a non-affected storage subsystem.

Ransomware attacks are becoming more common in containerized distributed computing environments. Containerization is the packaging of software code with just the operating system libraries and dependencies required to run the code to create a single lightweight executable, called a container, that runs consistently on any infrastructure. Unauthenticated endpoints and unpatched vulnerabilities in container runtime environments can be easy targets for ransomware attacks.

A growing number of containerized distributed computing environments utilize a container storage interface that provides users with the ability to provision and manage storage volumes in storage subsystems in the environment. The container storage interface processes requests to create a storage volume, expand a storage volume, create a snapshot of a storage volume, etc. Many such environments also run their own cyber threat detection software or subscribe to an external monitoring service that runs cyber threat detection software for the purpose of detecting cyber threats to the computing elements in the environment. Based in part on the proliferation of ransomware attacks, it is common for cyber threat detection software to automatically trigger taking a snapshot of all the persistent storage in a storage subsystem in response to detecting a threat to an application associated with the storage subsystem. In such situations, the request for the snapshot operation is generated internally and passed to the container storage interface for handling. A problem arises, however, in that the container storage interface maintains a queue of pending operations and performs operations associated with the requests in a serial fashion. As such, a request to perform a snapshot operation of a persistent volume may languish in the queue even though the request is generated based on a detected ransomware threat. As a result, precious time may be lost while the container storage interface works through the requests in its queue before it performs the snapshot operation that was requested to mitigate a ransomware attack.

Implementations of the invention address this problem by providing a system, method, and computer program product that are configured to: dynamically provision a webhook in a control plane of a cluster in response to receiving an indication of a threat to a storage subsystem associated with the cluster, wherein the webhook filters requests from external user devices to a container storage interface in the cluster; instruct the container storage interface to clear a queue of pending storage volume operations associated with the storage subsystem; determine priority operations for mitigating the threat, wherein the priority operations comprise a snapshot operation of an affected storage volume in the storage subsystem; and send the priority operations to the container storage interface for immediate processing. Implementations cause the container storge interface to clear its queue of pending operations based on determining an urgent need for a snapshot operation in response to a detected threat. Implementations also utilize the validating webhook to prevent new requests from arriving at the container storage interface. Both of these actions (e.g., clearing the queue and preventing new requests from entering the queue) speed up the time in which the container storage interface may perform the snapshot operation urgently needed to mitigate the detected ransomware threat. In this manner, implementations provide a technical solution to the technical problem of threat-mitigating snapshot operations waiting too long in a container storage interface queue.

In embodiments, there is a method including: identifying a storage subsystem that is associated with a cyber threat, wherein the storage subsystem is in a cluster in a distributed computing system; instructing a container storage interface in the cluster to clear a queue of pending operations associated with the storage subsystem; determining a priority operation associated with the storage subsystem for mitigating the cyber threat; and sending the priority operation to the container storage interface for processing. Instructing the container storage interface to clear its queue of pending operations provides the technical effect and advantage that the priority operation that is sent to the container storage interface will be performed essentially immediately without having to wait for other operations in the queue to be completed.

In embodiments of the method, the method further comprises provisioning a webhook in the cluster based on the identifying the storage subsystem. Provisioning a webhook in the cluster based on the identifying the storage subsystem provides the technical effect and advantage of dynamically creating a webhook that is configured to filter external requests associated with the storage subsystem that is identified as associated with the cyber threat.

In embodiments of the method, the webhook comprises a validating webhook. Using a validating webhook provides the technical effect and advantage of the filtering of requests being a validating type of filtering that admits some requests and blocks other request based on the parameters of the filtering.

In embodiments of the method, the webhook discards external requests involving storage volume operations associated with the storage subsystem. The webhook discarding external requests involving storage volume operations associated with the storage subsystem provides the technical effect and advantage of ensuring that no new requests are added to the queue of the container storage interface, so that the queue remains clear for processing the priority operation essentially immediately.

In embodiments of the method, the cluster includes plural storage subsystems, the storage subsystem is a respective one of the plural storage subsystems, the webhook discards external requests involving storage volume operations associated with the storage subsystem, and the webhook permits external requests involving storage volume operations associated with other ones of the plural storage subsystems. Discarding external requests involving storage volume operations associated with the storage subsystem provides the technical effect and advantage of ensuring that no new requests are added to the queue of the container storage interface, so that the queue remains clear for processing the priority operation essentially immediately. Permitting external requests involving storage volume operations associated with other ones of the plural storage subsystems provides the technical effect and advantage of ensuring that storage volumes in non-affected storage subsystems continue operating as normal, which is advantageous to users of the storage volumes that are not affected by the threat.

In embodiments of the method, the method further comprises receiving information associated with the cyber threat from a security information and event management system, where the identifying the storage subsystem is performed based on the received information. This provides the technical effect and advantage of being able to automatically detect the cyber threat and identify the storage subsystem associated with the cyber threat based on information received from the security information and event management system.

In embodiments of the method, the cyber threat is associated with an application running in the cluster, and the identifying the storage subsystem comprises determining the application utilizes a storage volume in the storage subsystem. This provides the technical effect and advantage of providing the benefits described herein when the cyber threat is directed to an application that utilizes a storage volume in the storage subsystem.

In embodiments of the method, the cyber threat is associated with a network object in the cluster, and the identifying the storage subsystem comprises determining the network object utilizes a storage volume in the storage subsystem. This provides the technical effect and advantage of providing the benefits described herein when the cyber threat is directed to a network object that utilizes a storage volume in the storage subsystem.

In embodiments of the method, the cyber threat comprises a ransomware attack. This provides the technical effect and advantage of providing the benefits described herein when the cyber threat is a ransomware attack.

In embodiments of the method, the priority operation comprises a snapshot operation of a storage volume in the storage subsystem. This provides the technical effect and advantage of taking a snapshot of the affected storage volume when the cyber threat is a ransomware attack so that an owner of the data in the affected storage volume may restore their data without paying the ransom.

In embodiments, there is a computer program product comprising one or more computer-readable storage media and program instructions stored on the one or more computer-readable storage media to perform operations comprising: identifying a storage subsystem that is associated with a cyber threat, wherein the storage subsystem is in a cluster in a distributed computing system; instructing a container storage interface in the cluster to clear a queue of pending operations associated with the storage subsystem; determining a priority operation associated with the storage subsystem for mitigating the cyber threat; and sending the priority operation to the container storage interface for processing. Instructing the container storage interface to clear its queue of pending operations provides the technical effect and advantage that the priority operation that is sent to the container storage interface will be performed essentially immediately without having to wait for other operations in the queue to be completed.

In embodiments of the computer program product, the operations further comprise provisioning a webhook in the cluster based on the identifying the storage subsystem and prior to the instructing. Provisioning a webhook in the cluster based on the identifying the storage subsystem provides the technical effect and advantage of dynamically creating a webhook that is configured to filter external requests associated with the storage subsystem that is identified as associated with the cyber threat.

In embodiments of the computer program product, the webhook comprises a validating webhook that discards external requests involving storage volume operations associated with the storage subsystem. The webhook discarding external requests involving storage volume operations associated with the storage subsystem provides the technical effect and advantage of ensuring that no new requests are added to the queue of the container storage interface, so that the queue remains clear for processing the priority operation essentially immediately.

In embodiments of the computer program product, the cluster includes plural storage subsystems, the storage subsystem is a respective one of the plural storage subsystems, the webhook discards external requests involving storage volume operations associated with the storage subsystem, and the webhook permits external requests involving storage volume operations associated with other ones of the plural storage subsystems. Discarding external requests involving storage volume operations associated with the storage subsystem provides the technical effect and advantage of ensuring that no new requests are added to the queue of the container storage interface, so that the queue remains clear for processing the priority operation essentially immediately. Permitting external requests involving storage volume operations associated with other ones of the plural storage subsystems provides the technical effect and advantage of ensuring that storage volumes in non-affected storage subsystems continue operating as normal, which is advantageous to users of the storage volumes that are not affected by the threat.

In embodiments of the computer program product, the operations further comprise receiving information associated with the cyber threat from a security information and event management system, and the identifying the storage subsystem is performed based on the received information. This provides the technical effect and advantage of being able to automatically detect the cyber threat and identify the storage subsystem associated with the cyber threat based on information received from the security information and event management system.

In embodiments, there is a computer system comprising a processor set, one or more computer-readable storage media, and program instructions stored on the one or more computer-readable storage media to cause the processor set to perform operations comprising: identifying a storage subsystem that is associated with a cyber threat, wherein the storage subsystem is in a cluster in a distributed computing system; instructing a container storage interface in the cluster to clear a queue of pending operations associated with the storage subsystem; determining a priority operation associated with the storage subsystem for mitigating the cyber threat; and sending the priority operation to the container storage interface for processing. Instructing the container storage interface to clear its queue of pending operations provides the technical effect and advantage that the priority operation that is sent to the container storage interface will be performed essentially immediately without having to wait for other operations in the queue to be completed.

In embodiments of the computer system, the operations further comprise provisioning a webhook in the cluster based on the identifying the storage subsystem and prior to the instructing. Provisioning a webhook in the cluster based on the identifying the storage subsystem provides the technical effect and advantage of dynamically creating a webhook that is configured to filter external requests associated with the storage subsystem that is identified as associated with the cyber threat.

In embodiments of the computer system, the webhook comprises a validating webhook that discards external requests involving storage volume operations associated with the storage subsystem. The webhook discarding external requests involving storage volume operations associated with the storage subsystem provides the technical effect and advantage of ensuring that no new requests are added to the queue of the container storage interface, so that the queue remains clear for processing the priority operation essentially immediately.

In embodiments of the computer system, the cluster includes plural storage subsystems, the storage subsystem is a respective one of the plural storage subsystems, the webhook discards external requests involving storage volume operations associated with the storage subsystem, and the webhook permits external requests involving storage volume operations associated with other ones of the plural storage subsystems. Discarding external requests involving storage volume operations associated with the storage subsystem provides the technical effect and advantage of ensuring that no new requests are added to the queue of the container storage interface, so that the queue remains clear for processing the priority operation essentially immediately. Permitting external requests involving storage volume operations associated with other ones of the plural storage subsystems provides the technical effect and advantage of ensuring that storage volumes in non-affected storage subsystems continue operating as normal, which is advantageous to users of the storage volumes that are not affected by the threat.

In embodiments of the computer system, the operations further comprise receiving information associated with the cyber threat from a security information and event management system, and the identifying the storage subsystem is performed based on the received information. This provides the technical effect and advantage of being able to automatically detect the cyber threat and identify the storage subsystem associated with the cyber threat based on information received from the security information and event management system.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as watcher service proxy code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

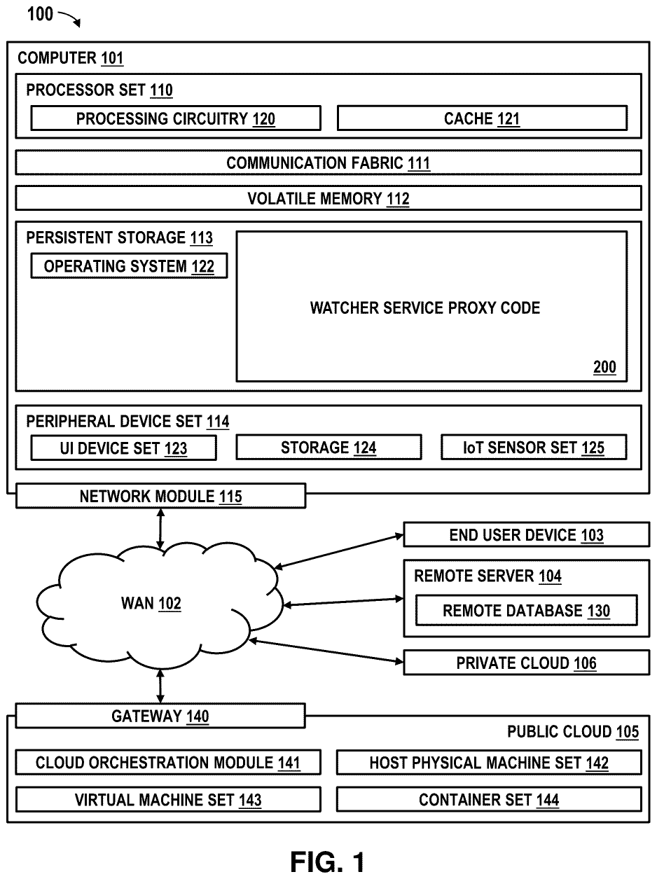

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

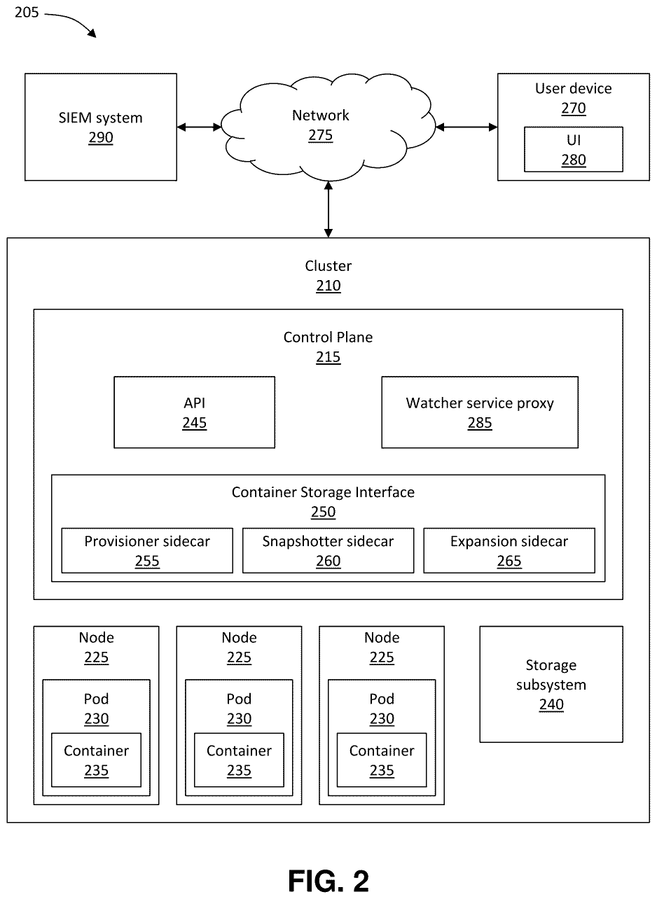

FIG. 2 shows a block diagram of an exemplary environment 205 in accordance with aspects of the invention. In embodiments, the environment 205 is a containerized distributed computing environment that includes a cluster 210 that includes a control plane 215, nodes 225, and a storage subsystem 240. In embodiments, the cluster 210 is a container orchestrated computing cluster such as a Kubernetes cluster. Kubernetes is an open-source container orchestration system for automating software deployment, scaling, and management. Aspects of the present disclosure are described using Kubernetes as an example; however, embodiments of the invention are not limited to use with Kubernetes. Instead, embodiments may be used with any suitable container orchestration system.

In embodiments, the cluster 210 comprises any number of nodes 225 that run one or more applications that provide services to end user devices. In one example, each node 225 comprises a computing device (e.g., a bare-metal server or virtual machine) that hosts one or more pods 230. In this example, each pod 230 contains one or more containers 235 such as Docker containers. In an exemplary operation, the pods 230 run on the nodes 225 and represent a single instance of a running process in the cluster 210.

In accordance with aspects of the invention, the control plane 215 comprises a control plane application program interface (API) 245, a container storage interface (CSI) 250, and a watcher service proxy 285, each of which may run on one or more nodes (not shown) similar to the nodes 225. The API 245 lets end users, different parts of the cluster 210, and external components communicate with one another. The API 245 may comprise the Kubernetes API, for example. In embodiments, the control plane 215 manages the nodes 225 and the pods 230, e.g., via scheduling, scaling, and other operations.

In embodiments, the CSI 250 is an interface driver that a user may utilize to provision storage volumes in the storage subsystem 240 for use by applications deployed in containers 235 in the cluster 210. The CSI 250 may include one or more sidecar containers, such as a provisioner sidecar 255, a snapshotter sidecar 260, and an expansion sidecar 265, which are containers that simplify the development and deployment of drivers used in the cluster 210.

In embodiments, the storage subsystem 240 comprises storage (e.g., hardware storage) in which storage volumes can be created for use by different applications deployed in containers 235 in the cluster 210. In embodiments, the storage volumes are persistent storage volumes (also called persistent volumes). The storage subsystem 240 can be, for example, in an external storage system or a software defined storage system (SDS). The storage subsystem 240 comprises persistent storage that is separate from local storage on nodes 225, which is ephemeral and is deleted when a pod shuts down.

With continued reference to FIG. 2, the environment 205 may further comprise a user device 270 that communicates with the cluster 210 via a network 275. In embodiments, the user device 270 comprises one or more instances of the EUD 103 of FIG. 1. In embodiments, the network 270 comprises one or more networks for communicating computer data, such as the WAN 102 of FIG. 1. In embodiments, the user device 270 comprises software that communicates with the cluster 210 and that provides a user interface (UI) 280 by which the user may submit requests to the CSI 250, via the API 245, for performing operations associated with provisioning and managing storage volumes used by applications that are running in the cluster 210. For example, a user may utilize the UI 280 to send various requests to the CSI 250 via the API 245, the requests involving storage volume operations including but not limited to: creating a new storage volume in the storage subsystem 240; expanding an existing storage volume in the storage subsystem 240; creating a snapshot of a storage volume in the storage subsystem 240; deleting a snapshot of a storage volume in the storage subsystem 240; cloning a storage volume in the storage subsystem 240; restoring a storage volume in the storage subsystem 240; and deleting a storage volume in the storage subsystem 240.

In accordance with aspects of the invention, the watcher service proxy 285 is configured to provide a cyber watcher service proxy for the CSI 250. In embodiments, the watcher service proxy 285 receives event notifications from a cyber watcher service, such as security information and event management (SIEM) system 290, that is configured to detect cyber security threats to the cluster 215 including ransomware events directed to the storage subsystem 240.

In embodiments, in response to receiving the indication of a threat to the storage subsystem 240, the watcher service proxy 285 is configured to: dynamically provision a webhook in the control plane 210 between the user device 270 and the API 245, wherein the webhook filters requests from the user device 270 to the CSI 250; instruct the CSI 250 to clear a queue of pending storage volume operations associated with the storage subsystem 240; determine one or more priority operations based on the threat; and send the one more priority operations to the CSI 250 for processing, which will be performed essentially immediately since the queue of the CSI 250 is empty.

In embodiments, the webhook is a validating webhook that intercepts an incoming request to the CSI 250 before the request is processed by the API 245. The validating webhook may comprise a which comprises a Hypertext Transfer Protocol (HTTP) callback, for example. In accordance with aspects of the invention, the watcher service proxy 285 dynamically creates the webhook based on an affected storage volume in the storage subsystem 240. In some embodiments, the affected storage volume is directly affected by the threat identified by the SIEM system 290, e.g., as in a ransomware attack, while in some other embodiments, a respective storage volume is identified as the affected storage volume based on the respective storage volume being utilized by something else in the cluster 210, such as an application running on a node 225 in the cluster 210 and utilizing the respective storage volume. In embodiments, the watcher service proxy 285 dynamically creates the webhook to intercept and discard requests to the CSI 250 to perform storage volume operations that are associated with the affected storage volume. In one example, the webhook discards all requests that are directed to the CSI 250. In another example, the cluster 210 includes plural storage subsystems 240, the affected storage volume is included in a respective one of the plural storage subsystems 240, and the webhook discards requests to the CSI 250 that are associated the respective one of the plural storage subsystems 240 while passing requests to the CSI 250 that are associated the other ones of the plural storage subsystems 240 that do not include the affected storage volume.

In embodiments, the watcher service proxy 285 comprises one or more modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. In one example, the watcher service proxy 285 runs in a container on a node in the control plane 215.

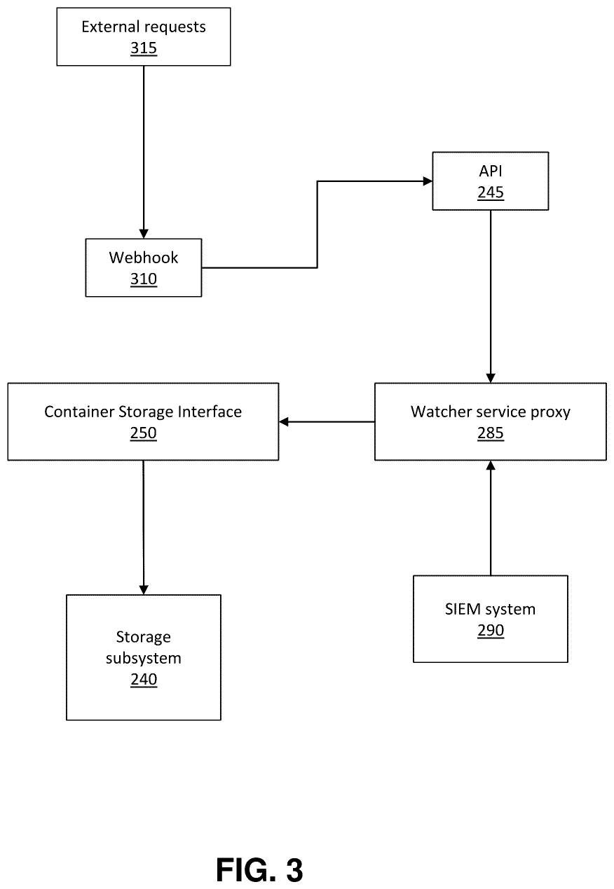

FIG. 3 shows an exemplary use case that illustrates aspects of the invention. Operations carried out in the use case may be performed in the environment of FIG. 2 and are described with reference to elements depicted in FIG. 2. In this use case, the SIEM system 290 detects a threat to an application running in the cluster 210 (not shown) and that utilizes a storage volume in the storage subsystem 240. In this example, the SIEM system 290 provides information associated with the threat to the watcher service proxy 285. The information may include, but is not limited to, a type of threat, an identification of the application affected by the threat, an identification of a storage subsystem affected by the threat, etc. In accordance with aspects of the invention, the watcher service proxy 285 dynamically provisions a webhook 310 to block external requests 315 (e.g., from user device 270 not shown) that are directed to CSI 250 and associated with the storage subsystem 240. In accordance with aspects of the invention, the watcher service proxy 285 instructs the CSI 250 to discard all operations that are pending in its queue and that are associated with storage subsystem 240. In accordance with aspects of the invention, the watcher service proxy 285 determines priority operations including, for example, snapshotting a storage volume in the storage subsystem 240 that is affected by the threat. In accordance with aspects of the invention, the watcher service proxy 285 sends the priority operations to the CSI 250, which performs the priority operations immediately since there are no operations pending in the queue. In embodiments, the watcher service proxy 285 permits requests generated internally, e.g., at the API 245, to pass through to the CSI 250.

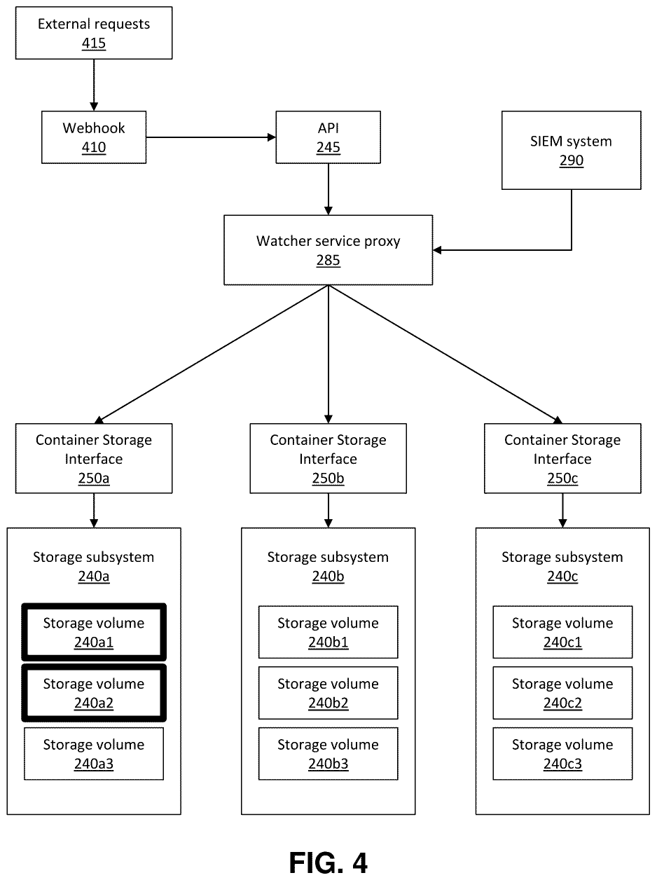

FIG. 4 shows another exemplary use case that illustrates aspects of the invention. Operations carried out in the use case may be performed in the environment of FIG. 2 and are described with reference to elements depicted in FIG. 2. In this use case, the cluster 210 (not shown) includes three different storage subsystems: storage subsystem 240a that includes storage volumes 240a1, 240a2, and 240a3; storage subsystem 240b that includes storage volumes 240b1, 240b2, and 240b3; and storage subsystem 240c that includes storage volumes 240c1, 240c2, and 240c3. In this use case, the cluster 210 (not shown) includes three instances of CSI 250a, 250b, and 250c associated with the storage subsystems 240a, 240b, and 240c. In this example, the SIEM system 290 detects a threat to an application running in the cluster and that utilizes storage volumes 240a1 and 240a2. These affected storage volumes are designated in FIG. 4 with bold boxes. In this example, the SIEM system 290 provides information associated with the threat to the watcher service proxy 285. The information may include, but is not limited to, a type of threat, an identification of the application affected by the threat, an identification of a storage subsystem affected by the threat, an identification of a storage volume affected by the threat, etc. In accordance with aspects of the invention, the watcher service proxy 285 dynamically provisions a webhook 410 to filter external requests 415 (e.g., from user device 270 not shown) that are directed to the CSIs 250a-c and associated with the storage subsystems 240a-c. In this example, the webhook 410 discards (e.g., blocks) ones of the external requests 415 that are directed to the CSI 250a that is associated with the affected storage volumes 240a1 and 240a2. In this example, the webhook 410 permits (e.g., validates) ones of the external requests 415 that are directed to the CSI 250b and the CSI 250c that are not associated with the affected storage volumes 240a1 and 240a2, such that the CSI 250b and the CSI 250c continue operating as normal, which is advantageous to users of the storage volumes 240b1-3 and 240c1-3 that are not affected by the threat. In this example, the watcher service proxy 285 instructs the CSI 250a to discard all operations that are pending in its queue and that are associated with storage subsystem 240a. In accordance with aspects of the invention, the watcher service proxy 285 determines priority operations including, for example, snapshotting storage volumes 240a1 and 240a2 that are affected by the threat. In accordance with aspects of the invention, the watcher service proxy 285 sends the priority operations to the CSI 250a, which performs the priority operations immediately since there are no operations pending its queue.

As is understood from FIGS. 2-4 and the associated descriptions, implementations of the invention provide a method to enable a new watcher service in a CSI driver network which acts as a proxy for any incoming operations (e.g., requests) to each CSI driver instance for their respective storage subsystem. In embodiments, the watcher service is configured to: connect to and obtain threat information from cyber security monitoring software (e.g., the SIEM system 290) running internally or externally to the cluster; determine the attack scope (e.g., such as single/multiple customer(s) in the case of public/private cloud(s) or individual/multiple storage subsystem hosting a single business application); and define one or more priority operations to be performed automatically based on the threat type (e.g., such as in case of ransomware attack on application data, performing a storage volume snapshot operation and/or making file-set data immutable). In embodiments, based on threat information obtained from the cyber security monitoring software (e.g., the SIEM system 290), the watcher service is configured to: dynamically enable a webhook which will validate/discard any new storage volume related request coming to Kubernetes API server based on the attack scope; send the priority operation(s) to the respective CSI driver socket to perform the defined priority operation(s) on the affected storage subsystem. In embodiments, based on threat information obtained from the cyber security monitoring software (e.g., the SIEM system 290), the watcher service is configured to: collect details associated with the affected storage volume(s) in the cluster before sending the priority operation(s) to the respective CSI driver socket. In embodiments, based on threat information obtained from the cyber security monitoring software (e.g., the SIEM system 290), the watcher service proxy is configured to define the attack scope according to one of the following: in the event only one consumer is affected in cloud or cloud-like environment, the watcher service proxy filters requests to the storage volumes for the applications associated with this one consumer (e.g., those applications that are running in the cluster under an account associate with this one consumer); in the event only certain application types are affected, the watcher service proxy filters requests to the storage volumes serving persistent storage to applications of the types that are affected; in the event the affected storage volume(s) are only on one storage subsystem, the watcher service proxy takes action on all the storage volumes being served by that storage subsystem. In embodiments, the CSI driver framework accepts the priority operation requests from the watcher service proxy and is only serving these priority operation requests while any other Kubernetes API service requests are being discarded.

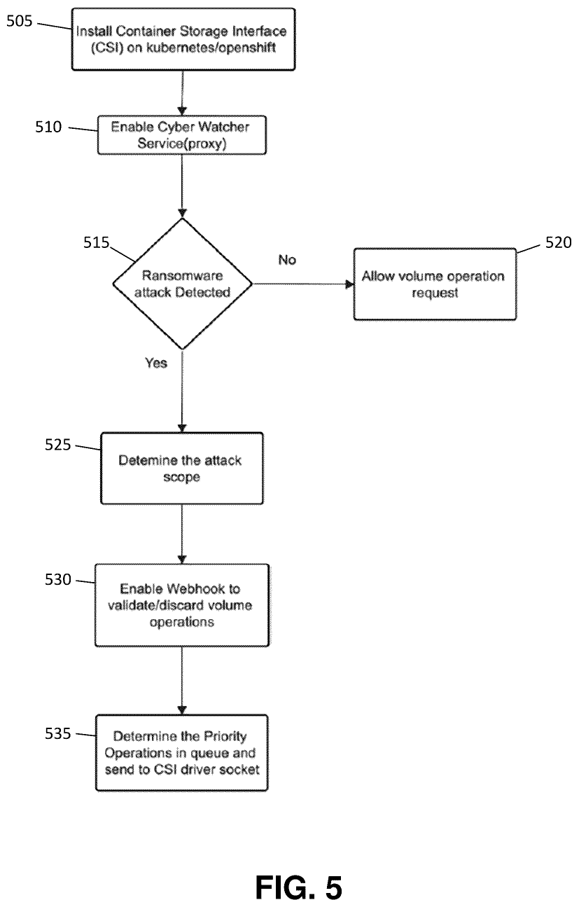

FIG. 5 shows a flowchart of an exemplary method in accordance with aspects of the present invention. Steps of the method (also referred to as operations) may be carried out in the environment of FIG. 2 and are described with reference to elements depicted in FIG. 2.

At step 505 the system installs the CSI 250 in the cluster 210. At step 510 the system enables the cyber watcher service (e.g., watcher service proxy 285). In embodiments, the watcher service proxy 285 is automatically enabled when the CSI driver is installed, which enables various types of storage volume operations such as storage volume creation/deletion, snapshot creation/deletion, storage volume expansion, etc. In embodiments, the watcher service proxy 285 is introduced as a proxy service between the API 245 and the CSI 250 and is configured to: intercept all requests to the CSI 250; operate as passthrough in case of no cyber-attack identified in the system; collect information about all cyber security threats to the cluster 210 from cyber threat monitoring software (e.g., the SIEM system 290); once a threat is detected and reported by the SIEM system 290, the watcher service proxy 285 scans the threat event details and identifies affected storage subsystem impacted by the threat; in the event the threat affects all the storage subsystems in the cluster, the watcher service proxy 285 blocks any further CSI traffic (e.g., external requests) to the CSI 250 driver by enabling the admission webhook; and the watcher service proxy 285 assists in prioritizing CSI requests which can help secure the affected data, such as storage volume snapshot requests.

At step 515 the watcher service proxy 285 determines whether a threat (e.g., a ransomware attack) has been detected by the SIEM system 290. If no threat has been detected, then at step 520 the watcher service proxy 285 acts as a pass-through by permitting storage volume operation requests to flow from an external user device to the API 245 and then to the CSI 250. If a threat such as a ransomware threat to one of the storage subsystems has been detected, then the method proceeds to step 525.

At step 525 the watcher service proxy 285 determines a scope of the threat, e.g., an attack scope. In embodiments, the SIEM system 290 provides detailed information about the threat to the watcher service proxy 285. In embodiments, based on the detailed information about the threat received from the SIEM system 290, the watcher service proxy 285 determines details about the object(s) in the cluster that are affected by the threat, such as: if the object affected by the threat is a storage related object such as a storage volume, then the watcher service proxy 285 identifies the storage subsystem details that are affected; if the object affected by the threat is an application related object such as a pod 230, then the watcher service proxy 285 scans the pod details to identify any storage volumes in the storage subsystem 240 being utilized by an application running in the pod, and deems those identified storage volumes as the affected storage volumes; if the object affected by the threat is a service/network related hardware object such as service, router, etc., then the watcher service proxy 285 identifies any storage volumes in the storage subsystem 240 being utilized by service/network related object, and deems those identified storage volumes as the affected storage volumes; and the watcher service proxy 285 focuses the scope to a particular storage subsystem in a plurality of storage subsystems in the cluster, so that the threat does impact the non-affected storage subsystems. In embodiments, based on a ransomware attack being detected, the watcher service proxy 285 determines the scope of the attack with respect to whether the attack is directed to a single customer or multiple customers, whether affected storage volumes are in a public or private cloud, and whether individual or multiple storage subsystems host an application associated with the attack. In embodiments, once the exact number of affected customers is determined, then the watcher service proxy 285 determines the scope of the affected storage volumes for filtering requests to storage subsystems containing the affected storage volumes associated with the application that is associated with the threat. In embodiments, if only one storage subsystem is impacted, then all storage volumes under that storage subsystem may be deemed as in-scope.

At step 530 the system enables a webhook to validate or discard requests for storage volume operations associated with the affected storage subsystem(s). In embodiments, the webhook filters all storage volume requests coming to the CSI 250 such as storage volume creation/deletion, snapshot creation/deletion, storage volume expansion, etc. In embodiments, the filtering comprises discarding requests that are associated with (e.g., directed to) an affected storage volume, e.g., a storage volume of a storage subsystem that is associated with an application that is associated with the threat. In embodiments, the filtering comprises allowing requests to storage subsystems that do not include affected storage volume. In embodiments, the filtering does not prevent the watcher service proxy 285 from passing the priority operations to the CSI 250 that includes the affected storage volume(s).

At step 535 the system determines and sends priority operations to the CSI driver socket (e.g., to the CSI 250). In embodiments, once the attack scope is determined and the validating webhook is enabled, the watcher service proxy 285 determines priority operations for the storage subsystem that includes the affected storage volume. Examples of priority operations include but are not limited to: creating a snapshot of the affected storage volume; creating safeguard copies of data stored in the affected storage volume; making data in the affected storage volume immutable; creating a shallow copy of the data stored in the affected storage volume; and priority applications of other non-affected customers and/or applications. In embodiments, the watcher service proxy 285 sends the determine priority operations to the CSI 250 that is associated with the affected storage subsystem.

Implementations provide the advantage that priority threat-mitigating operations, such as snapshot creation of affected storage volumes, are accelerated and thus provide a better response to a detected ransomware attack. Implementations help a user restore their data from a snapshot after ransomware has been detected. Implementations advantageously ensure there is no congestion at the backend if multiple unusual requests are arriving. Implementations advantageously monitor all Kubernetes resources will be monitored so that there will be less risk of ransomware attacks.

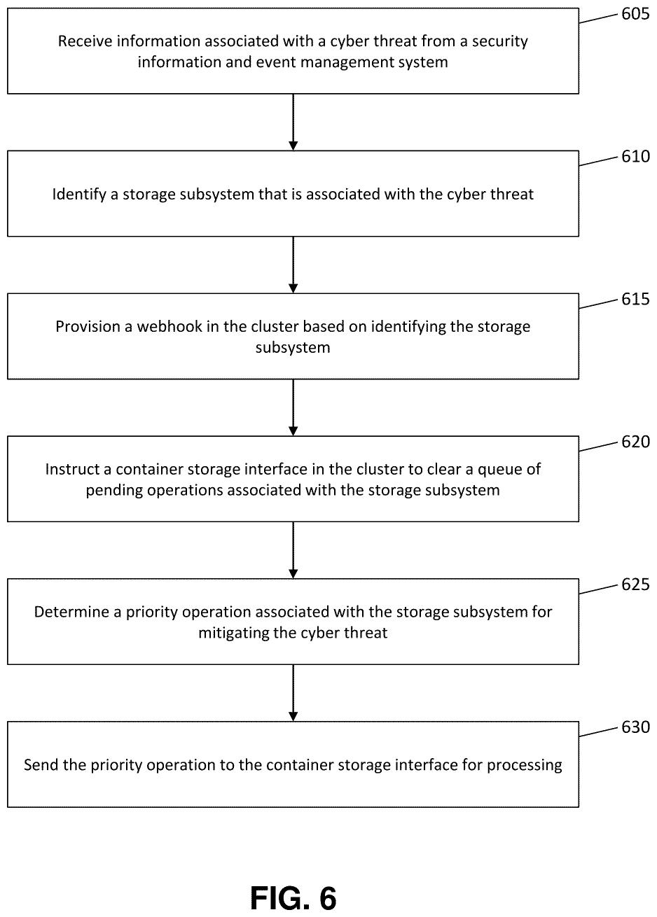

FIG. 6 shows a flowchart of an exemplary method in accordance with aspects of the present invention. Steps of the method (also referred to as operations) may be carried out in the environment of FIG. 2 and are described with reference to elements depicted in FIGS. 2-4.

At step 605 the system receives information associated with a cyber threat from a security information and event management system (e.g., SIEM system 290). In embodiments, the system is included in, or is part of, a containerized distributed computing environment, such as a Kubernetes cluster. At step 610 the system identifies a storage subsystem (e.g., storage subsystem 240) that is associated with the cyber threat from step 605. At step 615 the system provisions a webhook (e.g., webhook 310 or 410) in the cluster based on identifying the storage subsystem. At step 620 the system instructs a container storage interface (e.g., CSI 250) in the cluster to clear a queue of pending operations associated with the storage subsystem. In embodiments, the pending operations include pending storage volume operations such creation, deletion, snapshot or cloning. At step 625 the system determines a priority operation associated with the storage subsystem for mitigating the cyber threat. At step 630 the system sends the priority operation to the container storage interface for processing. In various embodiments, the webhook is established prior to instructing the container storage interface to flush its queue, so that no new external requests can be queued after the queue is flushed.

In embodiments of the method, the webhook comprises a validating webhook. In embodiments, the webhook discards external requests involving storage volume operations associated with the storage subsystem. In embodiments, the cluster includes plural storage subsystems, the storage subsystem is a respective one of the plural storage subsystems, the webhook discards external requests involving storage volume operations associated with the storage subsystem, and the webhook permits external requests involving storage volume operations associated with other ones of the plural storage subsystems.

In embodiments of the method, the identifying the storage subsystem is performed based on the received information. In one example, the cyber threat is associated with an application running in the cluster, and the identifying the storage subsystem comprises determining the application utilizes a storage volume in the storage subsystem. In another example, the cyber threat is associated with a network object in the cluster, and the identifying the storage subsystem comprises determining the network object utilizes a storage volume in the storage subsystem.

In embodiments of the method, the cyber threat comprises a ransomware attack and the priority operation comprises a snapshot operation of a storage volume in the storage subsystem.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
identifying a storage subsystem that is associated with a cyber threat, wherein the storage subsystem is in a cluster in a distributed computing system;
instructing a container storage interface in the cluster to clear a queue of pending operations associated with the storage subsystem;
determining a priority operation associated with the storage subsystem for mitigating the cyber threat; and
sending the priority operation to the container storage interface for processing.

2. The method of claim 1, further comprising provisioning a webhook in the cluster based on the identifying the storage subsystem.

3. The method of claim 2, wherein the webhook comprises a validating webhook.

4. The method of claim 2, wherein the webhook discards external requests involving storage volume operations associated with the storage subsystem.

5. The method of claim 2, wherein:
the cluster includes plural storage subsystems;
the storage subsystem is a respective one of the plural storage subsystems;
the webhook discards external requests involving storage volume operations associated with the storage subsystem; and
the webhook permits external requests involving storage volume operations associated with other ones of the plural storage subsystems.

6. The method of claim 1, further comprising receiving information associated with the cyber threat from a security information and event management system, wherein the identifying the storage subsystem is performed based on the received information.

7. The method of claim 1, wherein:
the cyber threat is associated with an application running in the cluster; and
the identifying the storage subsystem comprises determining the application utilizes a storage volume in the storage subsystem.

8. The method of claim 1, wherein:
the cyber threat is associated with a network object in the cluster; and
the identifying the storage subsystem comprises determining the network object utilizes a storage volume in the storage subsystem.

9. The method of claim 1, wherein the cyber threat comprises a ransomware attack.

10. The method of claim 9, wherein the priority operation comprises a snapshot operation of a storage volume in the storage subsystem.

11. A computer program product comprising:
one or more computer-readable storage media; and
program instructions stored on the one or more computer-readable storage media to perform operations comprising:
identifying a storage subsystem that is associated with a cyber threat, wherein the storage subsystem is in a cluster in a distributed computing system;
instructing a container storage interface in the cluster to clear a queue of pending operations associated with the storage subsystem;
determining a priority operation associated with the storage subsystem for mitigating the cyber threat; and
sending the priority operation to the container storage interface for processing.

12. The computer program product of claim 11, wherein the operations further comprise provisioning a webhook in the cluster based on the identifying the storage subsystem and prior to the instructing.

13. The computer program product of claim 12, wherein the webhook comprises a validating webhook that discards external requests involving storage volume operations associated with the storage subsystem.

14. The computer program product of claim 12, wherein:
the cluster includes plural storage subsystems;
the storage subsystem is a respective one of the plural storage subsystems;
the webhook discards external requests involving storage volume operations associated with the storage subsystem; and
the webhook permits external requests involving storage volume operations associated with other ones of the plural storage subsystems.

15. The computer program product of claim 11, wherein:
the operations further comprise receiving information associated with the cyber threat from a security information and event management system; and
the identifying the storage subsystem is performed based on the received information.

16. A computer system comprising:
a processor set;
one or more computer-readable storage media; and
program instructions stored on the one or more computer-readable storage media to cause the processor set to perform operations comprising:
identifying a storage subsystem that is associated with a cyber threat, wherein the storage subsystem is in a cluster in a distributed computing system;
instructing a container storage interface in the cluster to clear a queue of pending operations associated with the storage subsystem;
determining a priority operation associated with the storage subsystem for mitigating the cyber threat; and
sending the priority operation to the container storage interface for processing.

17. The computer system of claim 16, wherein the operations further comprise provisioning a webhook in the cluster based on the identifying the storage subsystem and prior to the instructing.

18. The computer system of claim 17, wherein the webhook comprises a validating webhook that discards external requests involving storage volume operations associated with the storage subsystem.

19. The computer system of claim 17, wherein:
the cluster includes plural storage subsystems;
the storage subsystem is a respective one of the plural storage subsystems;
the webhook discards external requests involving storage volume operations associated with the storage subsystem; and
the webhook permits external requests involving storage volume operations associated with other ones of the plural storage subsystems.

20. The computer system of claim 16, wherein:
the operations further comprise receiving information associated with the cyber threat from a security information and event management system; and
the identifying the storage subsystem is performed based on the received information.
